(19) United States
(12) Patent Application Publication
(10) Pub. No.: US 2003/0173470 A1
(43) Pub. Date: Sep. 18, 2003

(54) Conduit Isolator Mount

(76) Inventor: Gerard G. Geiger, Jackson, WI (US)

Correspondence Address: RYAN KROMHOLZ & MANION, S.C., POST OFFICE BOX 26618, MILWAUKEE, WI, 53226, US

(21) Appl. No.: 10/249,053

(22) Filed: Mar. 12, 2003

Related U.S. Application Data
(60) Provisional application No. 60/363,718, filed on Mar. 12, 2002.

(51) Int. Cl. F16L 3/16

(52) U.S. Cl. 248/55; 248/634

(57) ABSTRACT

A conduit isolator mount for separating and securing one or more elongate articles. In one embodiment the isolator may be used by itself to secure one or more elongate articles in relative position. In other embodiments, the isolator may be used in combination with conventional cable ties, saddle-type mounts, or button head cable ties and the like to secure and position the isolator mount to a desired support structure.

### RELATED APPLICATION

This application claims the benefit of provisional application Serial No. 60/363,718, filed Mar. 12, 2002.

### BACKGROUND OF INVENTION

This invention relates generally to specialized spacing mounts that can be used, for example, for separating conduits or other bundled elongate articles, such as brake lines, for mounting on a supporting structure, such as a vehicle frame rail.

Conduit spacers used in vehicle construction are generally known. Conduit spacers have been generally used to support elongate articles while providing standoff from a supporting surface. One such type of spacer is a molded plastic mount that, used with conventional cable ties, provides a mounting assembly. The mount is preferably interposed between one or more elongate articles and a structural member. A support surface of the mount is arranged to cradle and/or support elongate or bundled elongate items, with the mount further standing off the items from a mounting surface, such as a structural member. The mount may be further adapted for supporting engagement with the structural member.

Specialized button head ties are also known and serve to both secure the wires, tubes, etc. into bundles, and also to secure the resulting bundle to an adjacent supporting member. Such ties are typically constructed of two pieces: an elongate strap and a button head. The strap is molded with a tail finger grip on one end and a wedge shaped pawl including teeth thereon, on the other end. The wedge shaped pawl locks into an aperture in the button head. Serrations preferably extend along the length of the strap, which engage with the teeth on the wedge shaped pawl when looped back through the aperture of the head. The strap encircles the items to be bundled and is secured at both ends by the button. The button head tie may also be used in combination with a saddle mount, wherein the button head tie encircles the elongate bundle while the mount stands off the bundle from a supporting structure. An example of this arrangement may be seen in co-pending application Ser. No. 09/999,901 which is hereby incorporated by reference.

While such examples as known in the prior art are generally effective, convenient and easy to use, several problems have been noted when one or more wire conduit or fluid lines are mounted in close proximity to one another. For example, a hot hose bundle mounted adjacent a cold hose bundle can create unwanted thermal effect such as unacceptably warming the contents of the cold hose bundle. Vibration from the vehicle may also cause the various lines to vibrate alone, against one another, or against other components causing premature wear at bends and/or connection contact points with other components, and may also contribute to noise in the vehicle. Also, weight of the various lines and conduits may be too great for existing devices to handle in an acceptable manner.

The present invention provides a conduit isolator mount for elongate articles, such as brake lines in a vehicle, which serves as an additional support, clip, securement, cushion, isolator, brace, and insulating means to ameliorate the above-noted problems.

Further, the present invention may be used in combination with known devices such as cable ties, button-head ties and saddle mounts. For example, a simple cable tie may be used to secure one or more conduits to a mount.

### SUMMARY OF INVENTION

The present invention provides a spacer or isolator mount for elongate articles such as conduits, and in particular for vehicle brake lines, that can be used in lieu of or in conjunction with, prior art devices. In addition to brake lines, the invention can be used in conjunction with any similar structure, such as hoses, bundles of wire and the like. The conduit isolator mount of the present invention is adapted to be used in conjunction with prior art cable ties, button head ties and other known devices, such as saddle-type mounts, for separating and supporting elongate articles in secure engagement with a support structure such as a vehicle frame. The device is preferably integrally formed as a one-piece construction and includes a web portion and at least one radially spaced conduit support chamber adapted for supporting engagement of an elongate article. The support chamber is preferably arcuate and defines a longitudinal slot opening and at least one arcuate support surface. The axis of the arcuate surface being located transversely of the isolator as seen in cross section and preferably having ends of the arc being greater than 180 degrees. The ends of the arc provide the marginal edges for the slot, and may be resilient to provide a “snap fit” for retention of the conduit or other elongate article to be retained by the edges.

The conduit isolator mount of the present invention preferably accepts and secures one or more elongate articles to be secured in the support chamber. The elongate article to be secured is of a predetermined diameter that is adapted to be snap-fit into the slot formed by the arc and is further supported in the support chamber. The opening size of the support chamber may be the same size as the conduit or may be larger than the conduit to allow adjustment of the isolator mount longitudinally to the desired mounting location. Additionally, the conduit isolator of the present invention may be used in conjunction with conventional cable ties to provide further securement of elongate articles previously snap fit in the support chamber(s) of the conduit isolator mount. Further, the conduit isolator mount may be used with button head ties and other known devices, to secure the isolator mount to a support structure.

It is an object of the present invention to provide a conduit isolator mount that is convenient to use and economical to manufacture.

It is a further object of the present invention to provide a conduit isolator mount for use with a saddle mount and button head-type cable tie, to provide spaced-apart support alongside a support structure.

It is a further object of the invention to provide a conduit isolator mount for use in combination with button-type cable ties and standard cable ties that reliably and effectively secures elongate items into bundles alongside a supporting structure.

### BRIEF DESCRIPTION OF DRAWINGS

FIG. 1 is a perspective view of the conduit isolator of the present invention.

FIG. 2 is a perspective view of the conduit isolator shown in FIG. 1 with a conduit, such as a brake line, approaching entry into a retaining chamber formed in the conduit isolator mount.

FIG. 3 is a perspective view of the conduit isolator shown on FIGS. 1 and 2, but showing a conduit installed in one of several retaining chambers in the isolator.

FIG. 4 is a perspective view of the conduit isolator with a conduit installed in one of the retaining chambers and further secured by a conventional cable tie.

FIG. 5 is a front plan view of the conduit isolator shown in FIGS. 1-4.

FIG. 6 is a top plan view of the conduit isolator shown in FIGS. 1-5.

FIG. 7 is a sectional view of the conduit isolator shown in FIGS. 1-6 and taken along line 7-7 of FIG. 5.

FIG. 8 is a sectional view of the conduit isolator shown in FIGS. 1-7 and taken along line 8-8 of FIG. 5.

FIG. 9 is a perspective view of the conduit isolator in an installed condition and showing four conduits in place in retaining chambers with the isolator mounted on a frame rail by way of a conventional saddle mount and cable tie.

FIG. 10 is a perspective view of the conduit isolator of the present invention in an alternative installed condition, wherein the isolator is seen mounted on a frame rail using a saddle-type mount and button head cable tie.

FIG. 11 is a perspective view of the conduit isolator of the present invention in yet another installed condition, wherein the isolator is seen mounted on a frame rail in combination with a saddle-type mount and button head cable tie with additional conduits arranged alongside the isolator with conventional cable ties.

### DETAILED DESCRIPTION

Like features and structural elements are referred to by like reference characters.

The conduit isolator mount 10 of the present invention may be used to maintain one or more conduits 20, for example, hydraulic lines used in a commercial vehicle, in relative position. In one embodiment, the conduits 20 may be rigid tubes, for example, stainless steel brake lines as used on commercial vehicles. Often, the brake lines are required to span long runs along a truck chassis. The long spans of conduit result in unwanted deflection of the lines. Often, more than one brake line runs in close parallel proximity to other similar lines. Therefore, the unwanted vibration in the lines may cause damaging deflection or may cause the various lines to impact each other. To eliminate this undesirable condition, the conduit isolator mount 10 of the current invention may be inserted between one or more lines to maintain the relative position of each line. Further, strategic placement of the conduit isolator mount 10 aids in eliminating bending of the long spans of lines and in greatly reducing vibration.

As seen in the various Figures, the conduit isolator mount 10 preferably includes a web portion 11 and at least one snap-in conduit support chamber 12 to allow for easy assembly and installation of the conduit isolator mount 10 to elongate article, such as conduits 20. A snap-in feature is further provided to retain and secure the conduits 20.

While one embodiment of the conduit isolator mount 10 is circular in cross section and includes four conduit support chambers 12, it is contemplated that other configurations may be desired. Additional conduit support chambers 12 may be added or subtracted and various profiles may be used, as the need dictates, without departing from the spirit of the invention.

The conduit isolator mount 10 seen in the Figures is preferably injection molded, extruded (when a web-free configuration may be desired), or machined from a resilient polymer, such as thermoplastic vulcanized rubber or thermoplastic elastomer. Although this is preferred, it is conceivable that the isolator mount 10 may include a web 11 area of an alternative material having the support chambers 12 defined by a resilient material and affixed to the web 11. Accordingly, surface details are optimized for the manufacturing process, and are not pertinent to the invention, as one skilled in the art would readily recognize. It is important that the conduits or elongate articles of interest 20 preferably snap into each conduit support chamber 12 easily by hand insertion. The resilient material provides easy insertion and is somewhat forgiving if the conduits are not perfectly straight and spacing is not exactly the required amount. Furthermore, the resilient material absorbs and dampens vibration. In one embodiment, the conduit support chamber 12 preferably provides sufficient frictional engagement of the conduit 20 to secure the conduit isolator mount 10 to the conduits 20 and thereby prevent sliding of the isolator mount 10 when mounted on vertically aligned conduit 20 without the assistance of additional hand force (i.e. not free fall, or slide by gravity). In an alternate embodiment, the conduit support chamber provides minimal frictional engagement of the conduit and thereby allows the installer to easily slide either the isolator mount 10 or conduit 20 into proper alignment with minimal effort.

Referring now to the drawings, specifically FIG. 1, one embodiment of the invention is shown. The conduit isolator mount 10 is seen as generally circular and having a longitudinal axis, a pre-selected circumference and a pre-selected width. Alternatively, the conduit isolator mount could have any other profile to mate or match a mounting or nesting location. In addition, the isolator could have a locator protrusion to maintain the conduit position and/or location and to prevent the twisting of multiple adjacent conduits. As seen in FIGS. 1-8, the conduit isolator mount 10 is shown as including four conduit support chambers 12 radially spaced along the web 11 and the longitudinal axis of the conduit isolator mount 10. Each conduit support chamber 12 preferably includes a longitudinal axis; the longitudinal axis of each conduit support chamber 12 being generally parallel to each other and further generally parallel to the longitudinal axis of the conduit isolator mount 10. The conduit support chambers 12 preferably define an arcuate, or C-shaped, support surface 14. The arcuate support surface 14 is preferably of at least 180 degrees and terminates in a pair of marginal or retaining surfaces 16. The retaining surfaces 16 define a longitudinal slot opening 18 interrupting the circumferential surface 19 of the conduit isolator mount 10. The slot opening 18 is preferably less than 180° so that the conduit isolator mount 10 more easily securely retains the desired elongate article 20 (seen particularly in FIG. 3). It will be apparent in the first embodiment that the diameter of arcuate support surface 14 of conduit support chamber 12 preferably corresponds to the pre-determined diameter of a selected conduit 20, thereby allowing the conduit 20 to fit snuggly in the conduit support chamber 12, as seen in FIG. 3.

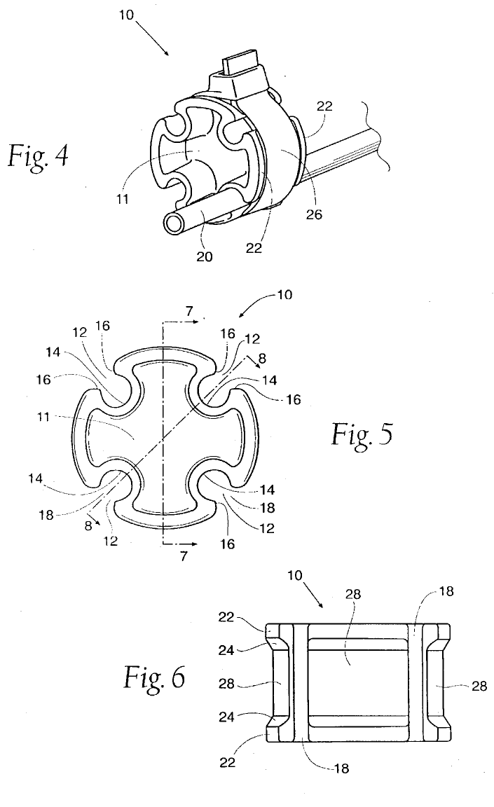

As may be seen in FIGS. 1-4, the conduit isolator mount 10 of the present invention may optionally further include a pair of longitudinally spaced, radially extending flanges 22 located on the circumferential surface 19 of the conduit isolator mount 10. These flanges 22 define opposing upstanding sidewalls 24. As may be seen in the Figures, while the flanges 22 and sidewalls 24 are not required to practice this invention, a preferred embodiment incorporates the flanges 22 and sidewalls 24 to facilitate location and retention of a cable tie 26 (seen particularly in the view of FIG. 4). Additional discussion of flanges 22 is so hereinafter set forth.

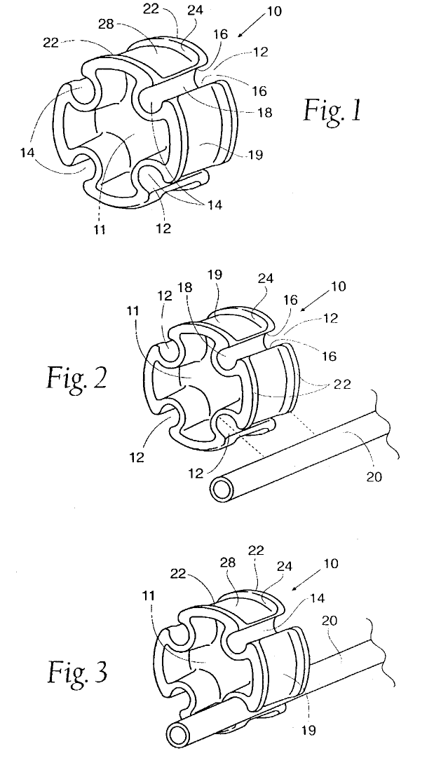

FIGS. 2 and 3 illustrate one use of the invention. As seen, an elongate article 20 may be inserted and snap-fit into a conduit support chamber 12 of the conduit isolator mount 10. As discussed, the relationship of the diameter of the elongate article or conduit 20 and the support surface 14 is such that the conduit 20 is retained by the retaining surfaces 16 in the conduit support chamber 12.

Referring now to FIG. 4, one intended use of the flanges 22 and sidewalls 24 may be seen. In this view, a traditional cable tie 26 is wrapped and cinched around the conduit isolator mount 10 and its retained conduits 20. In this manner, the retained conduits 20 are further secured, thereby enhancing the securing and locating aspects of the invention. Sidewise motion of the cable tie 26 relative to the isolator mount 10, is restricted by the opposed flanges 22.

As illustrated in FIG. 5, the conduit isolator mount 10 is seen in a front view. Four conduit support chambers 12 can be seen radially spaced from the longitudinal axis of the conduit isolator mount 10. Each conduit support channel 12 is of a generally arcuate or C-shaped configuration and includes a slot opening 18 and an arcuate support surface 14. The arcuate surface 14, or C-shape, extends beyond 180°, so that the diameter of the slot opening 18, necessarily, is less than the diameter of the conduit 20, of other elongate article, thereby facilitating a snap fit retention of the conduit 20 (not shown in this view).

The profile of the flanges 22 and sidewalls 24 is best seen in FIG. 6. The flanges 22 are oppositely disposed and, along with the surface 19, preferably define a circumferential groove portion 28. As illustrated in FIG. 6, the width of the groove 28 is predetermined by the placement of the sidewalls 24. The width of the groove 28 is generally determined by the width of the cable tie 26 to be used (see FIG. 4). The longitudinally spaced flanges 22 are preferably provided to aid in retention of the cable tie 26 around the conduit isolator mount 10, and to resist sidewise movement of a cable tie 26 (see FIG. 4) relative to the isolator mount 10.

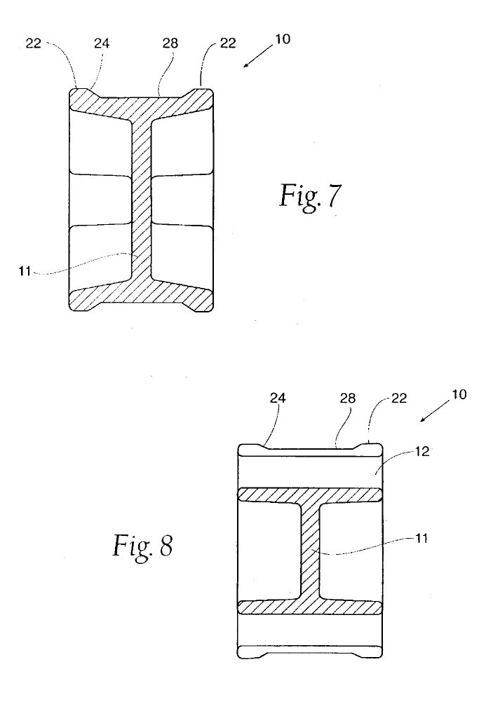

As illustrated in FIGS. 7 and 8, it can be seen that the conduit support chambers 12 are preferably coextensive of the width of the conduit isolator mount 10. As may be further seen in these views, the longitudinally spaced flanges 22 and sidewalls 24 may be spaced along the peripheral margins of the conduit isolator mount 10. However, it is to be understood that the flanges 22 may be spaced inwardly of the peripheral margins if, for example, a cable tie of a smaller width is employed.

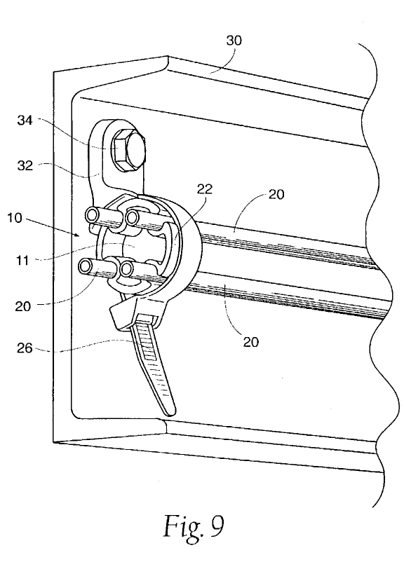

Referring now to FIG. 9, the conduit isolator mount 10 may be seen in installed condition in combination with a mount 32 and cable tie 26. Since some installation applications may require additional securing of the elongate articles 20, as mentioned above, the conduit isolator mount 10 may be adapted to receive a conventional cable tie 26. The cable tie 26 may be placed, for example, circumferentially about a peripheral edge of the conduit isolator mount and between the flanges 22 to thereby further secure the elongate articles 20 in the support chambers 12. As is illustrated in FIG. 9, the conduit isolator mount 10 and its retained conduits 20 may be further secured to a support member 30, such as a vehicle chassis. As seen, a mount 32 may be affixed to the conduit isolator mount 10 and the retained conduits 20 by looping a cable tie 26 around the isolator mount 10 and through an aperture (not shown) in the mount 32. The mount 32 and affixed isolator mount 10 may then be mounted on a support member 30, seen as a frame rail of a commercial vehicle in this view. The mount 32 is secured to the support member 30 by way of conventional fastening means, seen here as a bolt 34.

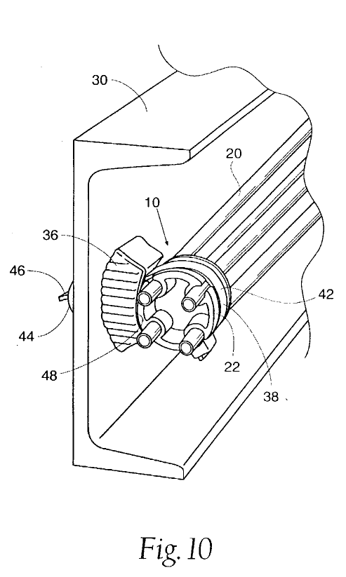

Referring now to FIG. 10, the conduit isolator mount 10 may be seen in another installed condition. In this view, the conduit isolator mount 10 is supported by a conventional apertured saddle mount 36 and button head tie 38 combination. This combination utilizes a button head tie 38 having an elongate strap 42 and an apertured button head 44. The strap 42 is molded with a tail finger grip 46 on one end and a wedge shaped pawl (not shown) including teeth thereon, on the other end. The pawl (not shown) locks into an aperture (not shown) in the button head 44. The saddle mount 36 includes a saddle or arched surface 48 arranged to cradle and support the conduit isolator mount 10 and its retained elongate articles 20 and further stand off the isolator mount 10 from the support member 30. The combination seen in FIG. 10 is secured to a support member 30 as the strap 42 of the button head cable tie 38 encircles the isolator mount 10, is inserted into the aperture (not shown) in the saddle mount 32, an aperture in the support member, and into the button head aperture where it is retained by the wedge shaped pawl.

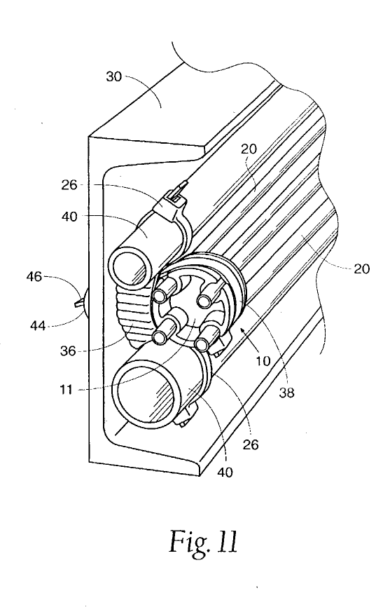

The versatility of the present invention is further illustrated in FIG. 11, wherein the conduit isolator mount 10 may be used with the saddle mount 36 and button head cable tie 38 of FIG. 10, and further in combination with conventional cable ties 26 surrounding elongate articles 40 of varying dimensions, as shown. As seen in this view, the conduit isolator mount 10 and its retained conduits 20 may share a saddle mount 36 with other elongate articles such as the rigid conduit 40 illustrated in this view. Additional elongate articles 40 are preferably retained along with the conduit isolator mount 10, on the saddle mount 36 by way of conventional cable ties 26.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A cylindrical conduit isolator mount having a longitudinal axis, a pre-selected circumference, and a pre-selected width, said conduit isolator including at least one conduit support chamber, said chamber being radially spaced from said longitudinal axis;
said chamber being arcuate and defining a longitudinal slot opening, said slot opening interrupting the circumferential surface of said mount.

2. The conduit isolator mount of claim 1 wherein said chamber is coextensive of the width of said conduit isolator mount.

3. The conduit isolator mount of claim 1 wherein said chamber includes a surface defined by an arc, said arc being of at least 180 degrees, said arc terminating in a pair of marginal surfaces.

4. The conduit isolator mount of claim 3 wherein said surface is comprised of a resilient material.

5. The conduit isolator mount of claim 3 wherein said slot opening is defined by said marginal surfaces.

6. The conduit isolator mount of claim 5 wherein said marginal surfaces are coextensive of the width of said conduit isolator mount.

7. The conduit isolator mount of claim 6 further including a pair of radially extending, longitudinally spaced, flanges.

8. The conduit isolator mount of claim 7 wherein said pair of longitudinally spaced flanges is interrupted by said marginal surfaces.

9. The conduit isolator mount of claim 1 wherein said mount is composed of a resilient material.

10. The conduit isolator mount of claim 7 wherein said pair of longitudinally spaced flanges define a groove located on a circumferential edge of said conduit isolator mount.

11. The conduit isolator mount of claim 10 wherein said groove is adapted to receive a cable tie around a circumferential portion of said isolator mount.

12. The conduit isolator mount of claim 1 in combination with a mounting assembly for securing said conduit isolator to a support member, said support member including a first side and a second side and an aperture communicating with each of said sides, said assembly including an elongated tie including a strap portion and a headed portion, said strap portion being arranged to be received by the aperture of said support member and further being arranged to circumscribe said isolator mount, and said headed portion being arranged to abut the first side of said support member; and
an apertured saddle mount interposed between said isolator mount and said support member, said saddle mount having a first surface and a second surface, said first surface being arranged for supporting engagement with said isolator mount and said second surface being adapted for supporting engagement with said second side of said support member.

13. The conduit isolator mount of claim 1 in combination with a mounting assembly for securing said conduit isolator to a support member, said support member including a first side and a second side and an aperture communicating with each of said sides, said assembly including an elongated tie including a strap portion and a headed portion, said strap portion being arranged to be received by the aperture of said support member and further being arranged to circumscribe said isolator mount, and said headed portion being arranged to abut the first side of said support member;
an apertured saddle mount interposed between said isolator mount and said support member, said saddle mount having a first surface and a second surface, said first surface being arranged for supporting engagement with said isolator mount and said second surface being adapted for supporting engagement with said second side of said support member; and
wherein said saddle mount includes oppositely disposed outer side surfaces for individually supporting respective ones of a pair of elongate articles, said outer side surfaces each being angularly disposed relative to said bottom surface.
